(19) United States
(12) Patent Application Publication
(10) Pub. No.: US 2024/0426044 A1
(43) Pub. Date: Dec. 26, 2024

(54) GARMENT PROCESSING DEVICE

(71) Applicant: LG Electronics Inc., Seoul (KR)

(72) Inventors: Daewoong KIM, Seoul (KR); Jeongguen CHOI, Seoul (KR); Dongjun CHOI, Seoul (KR); Yeona JO, Seoul (KR); Yuna JO, Seoul (KR); Jaemyung LIM, Seoul (KR); Hyunki KIM, Seoul (KR); Joonggil YOO, Seoul (KR); Minkyu OH, Seoul (KR); Sung Gul HWANG, Seoul (KR)

(21) Appl. No.: 18/707,131

(22) PCT Filed: Nov. 2, 2022
(86) PCT No.: PCT/KR2022/016985

§ 371 Date: May 2, 2024

(30) Foreign Application Priority Data
Nov. 2, 2021 (KR) 10-2021-0148504
Nov. 5, 2021 (KR) 10-2021-0151459
Nov. 5, 2021 (KR) 10-2021-0151460
Sep. 26, 2022 (KR) 10-2022-0121808

(51) Int. Cl. D06F 58/26; D06F 58/10; D06F 58/24; D06F 58/34

(52) U.S. Cl. CPC D06F 58/26; D06F 58/10; D06F 58/24; D06F 58/34

(57) ABSTRACT

The present application provides a garment processing device comprising: a cabinet having a cabinet chamber for providing a space in which garments are contained, and a cabinet introduction opening through which the cabinet chamber communicates with the outside; a first door capable of opening or closing the cabinet introduction opening; a door chamber provided on the first door so as to provide a garment containing space separated from the cabinet chamber, the door chamber comprising a chamber upper surface, a chamber bottom surface, a mounting surface connecting the chamber upper surface and the chamber bottom surface, and a mounting hole provided through the mounting surface; a second door provided on the first door and capable of opening/closing the door chamber; a hanger comprising a support body for supporting garments, a fastening portion for detachably fixing the support body in the mounting hole, a fastening portion channel provided in the fastening portion, and a support body channel provided in the support body so as to supply air supplied from the fastening portion channel to garments cradled on the support body; a heat exchange portion comprising a circulation channel for withdrawing air inside the door chamber to the outside of the door chamber and then guiding the air to the fastening portion channel, a fan provided in the circulation channel, and an air processing portion for executing at least one of dehumidification and heating of air introduced into the circulation channel; and a channel switching portion comprising a switching channel for connecting the circulation channel and the door chamber, and a switching valve for controlling the opening/closing of the switching channel.

### TECHNICAL FIELD

The present disclosure relates to a laundry treating apparatus. Specifically, the present disclosure relates to a laundry treating apparatus that has a separate space for caring for, storing, and displaying laundry or items.

### BACKGROUND

A laundry treating apparatus refers to an apparatus developed for washing and drying laundry at home and in a laundry, and for removing wrinkles on the laundry. What is classified as the laundry treating apparatus includes a washing machine that washes the laundry, a dryer that dries the laundry, a washing machine/dryer that has both a washing function and a drying function, a clothes care apparatus that refreshes the laundry, a steamer that removes the wrinkles from the laundry, and the like.

In particular, the clothes care apparatus is an apparatus that helps keep the laundry fresh and clean. The clothes care apparatus may remove fine dust attached to the laundry, deodorize the laundry, dry the laundry, and add fragrance to the laundry. In addition, generation of static electricity may be prevented, wrinkles may be removed from the laundry using dehumidified air or steam, and the laundry may be sterilized.

Korean Patent Application Publication No. 10-2014-0108454 discloses a typical laundry treating apparatus. That is, in a case of the typical laundry treating apparatus, a treatment room in which the laundry is accommodated and cared for using steam and hot air is formed inside a cabinet, and a hanger bar where the laundry is hung extends in a left and right direction inside the treatment room. A machinery room containing mechanical devices necessary for the laundry caring may be located under the treatment room and may supply hot air and steam to the treatment room. Additionally, when the laundry is hung on the hanger bar using a hanger, the laundry may be disposed in a front and rear direction of the cabinet. Additionally, the treatment room may be equipped with a shelf where a bag, a hat, and other goods that require care may be mounted.

However, this is an apparatus that focuses on simply caring for the laundry. Therefore, there is no separate space to display or store laundry inside. Additionally, using the treatment room may not also be energy efficient when an amount of laundry to be cared for is small. In one example, when a front surface of the door is made of a transparent material such that a user may check the laundry hung inside, an insulation performance via the front surface of the door is reduced, making it difficult to achieve the purpose of laundry caring.

In addition, because the hanger bar may only move in the left and right direction from a fixed location, there may be inconvenience in the user having to reach inside the treatment room to hang the laundry when hanging the laundry.

In addition, with a development of clothes and accessories made of various materials, there may be a need for a space to separately store and display laundry that require delicate care, such as a leather product or a silk product, or a separate space where temperature and humidity may be adjusted on a regular basis to store and display items such as the bag or the hat.

Korean Patent Application Publication No. 10-2019-0141286 discloses a laundry treating apparatus that separately has the treatment room for accommodating therein and caring for the laundry and a storage room where laundry that has been cared for is stored and the temperature is adjustable. However, there is a problem in that the laundry treating apparatus takes up a great amount of space indoors because the treatment room and the storage room are arranged in the left and right direction. In addition, because an air conditioner for the storage room is not disposed separately, but an air conditioner for the treatment room is used in the storage room in a connected manner, independent temperature and humidity adjustment only for the laundry stored in the storage room is not available during use of the treatment room.

In one example, Korean Patent Application Publication No. 10-2019-0139400 discloses a laundry treating apparatus with the treatment room and the storage room divided from each other in the front and rear direction, but a laundry caring function is equipped only in the treatment room and there is no separate mechanical device to manage the temperature and the humidity of the storage room. When the laundry that has been treated or cared for is simply stored in the storage room, the stored laundry may be affected by changes in surrounding temperature and humidity. For example, when the laundry is stored without the temperature and humidity adjustment, a moisture content of the laundry may increase and the laundry may become damp, or surrounding odors may be absorbed again. To solve such problem, an apparatus to manage the temperature and the humidity of the laundry even during the storage is needed.

In addition, Korean Patent Application Publication No. 10-2019-0139400 discloses a laundry treating apparatus in which the treatment room on a front side and the storage room on a rear side are separated from each other and the treatment room is hinged to a side surface of the storage room. However, considering an usage environment in which the laundry treating apparatus is used, a size of the laundry treating apparatus has no choice but to consider a standard size of furniture such as a typical closet. This is because the laundry treating apparatus is disposed next to or adjacent to the closet rather than being disposed alone indoors, away from the closet. Therefore, when the treatment room and the storage room are coupled to each other in a form similar to the hinge coupling of the typical door, durability of the hinge may be a problem because of a size of the treatment room, and interference may occur with the furniture located near when the treatment room pivots relative to the storage room. To solve such problem, the laundry treating apparatus should protrude forward as much as the size of the treatment room to resolve the interference between the surrounding furniture and the hinge. However, when the laundry treating apparatus protrudes more than other furniture, sense of unity with the surrounding furniture may be ruined.

Additionally, a new hinge structure that may withstand loads of the structure for the display room and the structure for supporting the display room may be needed. Additionally, the display room may be used as a space to show the accommodated laundry or the goods to the user and at the same time as a space where the laundry or the goods are able to be cared for. Therefore, it is necessary to have a separate mechanical device that may adjust the temperature and the humidity for the display room.

In one example, when considering a usage environment in which the laundry treating apparatus is used, a size of the laundry treating apparatus has no choice but to consider a standard size of furniture such as a general closet. This is because the laundry treating apparatus is disposed adjacent to and next to the closet rather than being disposed alone indoors away from the closet. Accordingly, when the display room or the showcase room is simply coupled to the laundry treating apparatus from the front, a front surface of the laundry treating apparatus may protrude forward as much as the display room compared to other adjacent furniture, thereby damaging a sense of unity.

On the other hand, when a portion of the treatment room where the laundry is accommodated is allocated for the display room, a space of the treatment room becomes smaller, so that an internal structure, for example, an arrangement direction of the hanger bar, and an air circulation direction may need to be changed.

### SUMMARY

### Technical Problem

First, the present disclosure is to provide a laundry treating apparatus with a space divided into a first chamber and a second chamber for caring of laundry or goods.

Second, the present disclosure is to provide the second chamber where temperature and humidity may be adjusted independently of the first chamber where temperature and humidity may be adjusted for sterilization, deodorization, drying, and wrinkle removal of laundry or goods.

Third, the present disclosure is to provide a hinge structure that may prevent interference with adjacent furniture when opening and closing a door assembly containing a second chamber, considering a size of the second chamber.

Fourth, the present disclosure is to provide a laundry treating apparatus where a hanger bar is disposed and an air circulation direction based on the hanger bar is set, considering a size of a space of the first chamber with a length in a front and rear direction reduced by the second chamber.

Fifth, the present disclosure is to provide a door assembly that may be automatically withdrawn from a cabinet by sensing opening of the door assembly by a user.

Sixth, the present disclosure is to enable check of laundry or goods accommodated in the second chamber via a front surface of the door assembly.

Seventh, the present disclosure is to allow illuminance and color of lighting that emits light toward the second chamber to be changed depending on laundry or goods.

Eighth, the present disclosure is to provide the first chamber that executes a course to care for laundry by receiving steam or hot air based on the course selected by the user, and the second chamber that constantly monitors inside temperature and humidity for laundry accommodated inside based on user's settings.

Ninth, the present disclosure provides a laundry treating apparatus equipped with a treatment space (a cabinet chamber) that treats laundry by spraying hot air and/or steam, and a showcase room (a door chamber) that is capable of displaying and treating laundry.

Tenth, the present disclosure is to provide a laundry treating apparatus that is able to adjust a temperature or a humidity of a showcase room via a single flow channel capable of dehumidification and blasting.

Eleventh, the present disclosure is to provide a laundry treating apparatus in which a process of adjusting a temperature or a humidity of a showcase room is independent of a process in progress in a treatment space.

Twelfth, the present disclosure is to provide a laundry treating apparatus equipped with a heat exchanger for adjusting a temperature or a humidity of laundry or accessories mounted in a showcase room.

Thirteenth, the present disclosure is to provide a laundry treating apparatus equipped with a clothes hanger and a heat exchanger that may supply air into laundry hung in a showcase room.

Fourteenth, the present disclosure is to provide a laundry treating apparatus that may control opening and closing of a flow channel that supplies air into laundry and a flow channel that supplies air into a showcase room via a clothes hanger.

Fifteenth, the present disclosure is to provide a laundry treating apparatus equipped with a hinge that prevents opening and closing of a showcase room from interfering with adjacent furniture or devices.

### Technical Solution

To solve the above-mentioned problems, provided is a laundry treating apparatus that simultaneously includes a styling area for caring for laundry and a showcase area for displaying laundry while caring for the same at all times. To solve the above-mentioned problems by dividing the styling area and the showcase area from each other, provided is the laundry treating apparatus that simultaneously has the styling area for caring for the laundry and the showcase area for storing and displaying the laundry while caring for the laundry at all times. By dividing the styling area and the showcase area from each other, a front surface of the showcase area may be made of a transparent material, so that an insulation performance of the styling area may be maintained while interior check is available.

Reflecting a size of the styling area that is reduced because of the showcase area, a hanger bar of the laundry treating apparatus may be disposed in a front and rear direction. On the other hand, an air circulation direction in a first chamber of the laundry treating apparatus may be a left and right direction.

Independently of air circulation and steam spray in the styling area, the laundry treating apparatus may include an air circulator and an air treater to adjust temperature and humidity in the showcase area.

The laundry treating apparatus may include a lighting device whose intensity and color may be adjusted to suit the laundry or items accommodated in the showcase area.

Considering a size of the showcase area, a door assembly including the showcase may be automatically extended and then slid. In addition, a separate door accessing the showcase may use a push & pull method.

More specifically, to solve above-mentioned problems, provided is a laundry treating apparatus including a cabinet including a first inlet defined in a front surface thereof, a first chamber that is located inside the cabinet and accommodates laundry or goods therein via the first inlet, an auxiliary chamber located at a lower side inside the cabinet and defining therein a space separated from the first chamber, a door assembly that opens and closes the first inlet, and a second chamber located inside the door assembly and defining therein a space separated from the first chamber and the auxiliary chamber to accommodate the laundry or the goods therein, and the first chamber includes a first area located on the auxiliary chamber, and a second area located in front of the auxiliary chamber and accommodating at least a portion of the second chamber therein when the door assembly closes the first inlet.

Along a front and rear direction of the cabinet, a front-and-rear length of the second area may be equal to or smaller than a front-and-rear length of the first area.

The laundry treating apparatus may further include a first chamber bottom surface forming a bottom surface of the first chamber, and the bottom surface of the first chamber may be formed to be stepped along the front and rear direction of the cabinet.

The first chamber bottom surface may include a first bottom surface forming a bottom surface of the first area, and a second bottom surface forming a bottom surface of the second area, and a vertical level of the first bottom surface may be higher than a vertical level of the second bottom surface.

The second bottom surface may face at least a portion of a lower portion of the door assembly when the door assembly closes the first inlet.

The door assembly may include an accommodating body including a second inlet defined in a front surface thereof to allow the second chamber formed therein to be in communication with the outside, and a door of the second chamber that opens and closes the second inlet, and at least a portion of the accommodating body may be accommodated in the first area when the door assembly closes the first inlet.

At least a portion of the door of the second chamber may be made of a material that allows visible light to pass therethrough.

A width of the accommodating body may decrease rearwards from the second inlet. That is, the accommodating body may have a tapered shape.

The laundry treating apparatus may further include a first hinge pivotably coupling the door assembly to the cabinet, and a second hinge pivotably coupling the door of the second chamber to the accommodating body.

The first hinge may include a plurality of first hinges.

The first hinge may include a first upper hinge located at an upper portion of the first chamber; and a first lower hinge located at a lower portion of the first chamber, a portion of each of the first upper hinge and the first lower hinge may be located spaced apart from both side surfaces of the first chamber, another portion of each of the first upper hinge and the first lower hinge may be pivotably coupled to a rear surface of the accommodating body so as to be spaced apart from both side surfaces of the accommodating body, and the first hinge may extend the door assembly forward of the cabinet and then move the door assembly along a width direction of the cabinet and pivot the door assembly to open the first inlet.

The second hinge may include a plurality of second hinges, and one end of each of the plurality of second hinges may be located in the accommodating body and the other end of each of the plurality of second hinges may be located on an inner surface of the door of the chamber facing the second inlet of the door of the second chamber, so that the second hinge may pivot the door such that an angle between the second inlet and the door of the second chamber increases or decreases.

The first hinge may include a first link and a second link that are pivotably coupled to the cabinet and the accommodating body, but are positioned spaced apart from each other.

The first link and the second link may move the door assembly parallel to the first inlet when opening and closing the first inlet

The first hinge may move the door assembly forward away from the first inlet via the pivoting of the first link and the second link, and then move the door assembly parallel to the first inlet.

The laundry treating apparatus may further include an opening/closing driver that is located on an inner surface of the first chamber and pushes the door assembly to separate the door assembly from the first inlet.

The opening/closing driver may include an opening/closing body that forms an outer appearance, an opening/closing motor disposed inside the opening/closing body, and an opening/closing link that is connected to the opening/closing motor and pushes the door assembly in a direction away from the first inlet when the opening/closing motor rotates.

The laundry treating apparatus may further include an air supply that is located inside the auxiliary chamber and circulates air in the first chamber, an air intake port located on a bottom surface of the first chamber, in communication with the first chamber, and sucking air from the first chamber into the air supply, and an air discharge port located on the bottom surface of the first chamber, in communication with the first chamber, and discharging air that has passed through the air supply into the first chamber.

The laundry treating apparatus may further include a first bottom surface forming a bottom surface of the first area, and a second bottom surface forming a bottom surface of the second area, and the air intake port and the air discharge port may be located on the first bottom surface.

The air intake port and the air discharge port may be disposed along the width direction of the cabinet.

The laundry treating apparatus may further include a steam supply that is located in the auxiliary chamber and generates and supplies steam to the first chamber, and a steam discharge port that is located at a bottom of the first chamber and discharges steam into the first chamber.

The steam discharge port may be located closer to the air discharge port than to the air intake port.

The laundry treating apparatus may further include a water supply tank that supplies water for generating the steam in the steam supply, and a drain tank that stores condensate generated in the air supply and the first chamber, and the water supply tank and the drain tank may be detachably inserted into the auxiliary chamber via a front surface of the auxiliary chamber.

Lengths of the water supply tank and the drain tank along the front and rear direction of the cabinet may be greater than lengths thereof along the height direction of the cabinet.

The air supply may further include a heat exchanger for dehumidifying and heating circulating air of the first chamber, and the water supply tank and the drain tank may be located above the heat exchanger.

The laundry treating apparatus may further include a hanger body that is located at an upper side inside the first chamber and hangs the laundry thereon, and the hanger body may extend along the front and rear direction of the cabinet.

The laundry treating apparatus may further include an air supply that is located in the auxiliary chamber and circulates air in the first chamber, an air intake port located at a lower portion of the first chamber, in communication with the first chamber, and sucking air from the first chamber into the air supply, and an air discharge port located at a lower portion of the first chamber, in communication with the first chamber, and discharging air that has passed through the air supply into the first chamber, and the air intake port and the air discharge port may be disposed to be spaced apart from each other in the width direction of the cabinet.

The laundry treating apparatus may further include a hanger support that supports the hanger body movably in the front and rear direction.

The laundry treating apparatus may further include a hanger bar fixing groove defined in one of the hanger support and the hanger body, and a movement preventing protrusion disposed on the other of the hanger support and the hanger body and insertable into the hanger bar fixing groove depending on whether the door assembly is opened.

The laundry treating apparatus may further include a laundry driver that generates a rotational force for a reciprocating movement of the hanger body, and a power converter connected to the laundry driver to cause the reciprocating movement of the hanger body along the front and rear direction.

The laundry treating apparatus may further include a hanger mounting portion for hanging the laundry accommodated in the second chamber, and a direction of the laundry hung on the hanger mounting portion may be the same as a direction of the laundry hung on the hanger body.

The laundry treating apparatus may further include an air circulator located inside the accommodating body to circulate air in the second chamber.

The laundry treating apparatus may further include an air treater located inside the accommodating body to circulate air in the second chamber.

The air circulator and the air treater may be operated even when the door assembly is opened.

The laundry treating apparatus may further include an air supply disposed inside the auxiliary chamber to circulate air in the first chamber, and the air circulator and the air treater may be operated independently of the operation of the air supply.

The air circulator may include a heater that heats circulating air of the second chamber to adjust a temperature of the second chamber.

The air treater may include a dehumidifier to dehumidify air circulating through the air treater.

The door assembly may further include a shelf that is detachably disposed in the second chamber and supports the laundry or the goods accommodated in the second chamber.

In one example, the laundry treating apparatus may include a cabinet including a first inlet defined in a front surface thereof, a first chamber that is located inside the cabinet and accommodates laundry or goods therein via the first inlet, an auxiliary chamber located at a lower side inside the cabinet and defining therein a space separated from the first chamber, and a door assembly that opens and closes the first inlet and includes a second chamber that accommodates the laundry or the goods therein, and at least a portion of the second chamber may be accommodated in a space between the first inlet and the auxiliary chamber when the door assembly closes the first inlet.

In one example, the laundry treating apparatus may include a cabinet including a first inlet defined in a front surface thereof, a first chamber that is located inside the cabinet and accommodates laundry or goods therein via the first inlet, an auxiliary chamber located at a lower side inside the cabinet and defining therein a space separated from the first chamber, a door assembly including a second inlet defined in a front surface thereof, including an accommodating body defining a second chamber therein and a door of the second chamber that opens and closes the second inlet, and opening and closing the first inlet, a first hinge that separates the door assembly from the first chamber and then moves the door assembly along the width direction of the cabinet to open the first inlet, and a second hinge that opens the second inlet by moving the door of the second chamber such that the angle between the door of the second chamber and the front surface of the accommodating body increases.

At least a portion of the second chamber may be located in front of the auxiliary chamber inside the first chamber when the door assembly closes the first inlet.

In one example, the laundry treating apparatus may include a cabinet including a first inlet defined in a front surface thereof, a first chamber that is located inside the cabinet and accommodates laundry therein via the first inlet, an auxiliary chamber located at a lower side inside the cabinet and defining therein an installation space separated from the first chamber, a door assembly that opens and closes the first inlet, and a first hinge that connects the door assembly to the cabinet, the door assembly may include an accommodating body including a second inlet defined in a front surface thereof and at least partially accommodated inside the first chamber when the door assembly is closed, a second chamber located inside the accommodating body, formed separately from the first chamber and the auxiliary chamber, and in communication with the outside via the second inlet, a door of the second chamber that opens and closes the second inlet, and a second hinge that connects the door of the second chamber to the accommodating body, the first hinge may extend the door assembly forward of the cabinet, move the door assembly along the width direction of the cabinet, and pivot the door assembly to open the first inlet, and the second hinge may pivot the door of the second chamber to open the second inlet.

The water supply tank and the drain tank may be located above the air supply or the steam supply.

In one example, the laundry treating apparatus may include a cabinet including a first inlet defined in a front surface thereof, a first chamber that is located inside the cabinet and accommodates laundry therein via the first inlet, an auxiliary chamber located at a lower side inside the cabinet and defining therein an installation space separated from the first chamber, and a door assembly that is coupled to the cabinet to open and close the first inlet, and the door assembly may include an accommodating body including a second inlet defined in a front surface thereof and at least partially accommodated inside the first chamber when the door assembly is closed, a second chamber located inside the accommodating body, formed separately from the first chamber and the auxiliary chamber, and in communication with the outside via the second inlet, and a door of the second chamber that opens and closes the second inlet.

The laundry treating apparatus may further include a first hinge that pivots such that the door assembly is extended forward of the cabinet and then moved along the width direction of the cabinet, and a second hinge that pivots to open the second inlet via the pivoting of the door of the second chamber when the door of the second chamber is opened.

When the door assembly is closed, the door assembly may move along the width direction of the cabinet to face the first inlet, and then close the first inlet.

Further, the present application provides a laundry treating apparatus including a cabinet including a cabinet chamber providing a space for accommodating laundry therein and a cabinet inlet allowing the cabinet chamber to be in communication with the outside, a first door that opens or closes the cabinet inlet, a door chamber defined in the first door to provide a laundry accommodation space separated from the cabinet chamber, wherein the door chamber includes a chamber top surface, a chamber bottom surface, a mounting surface connecting the chamber top surface with the chamber bottom surface, and a mounting hole defined through the mounting surface, a second door that is disposed at the first door and opens and closes the door chamber, a clothes hanger including a support body where the laundry is supported, a fastening portion detachably fixing the support body to the mounting hole, a fastening portion flow channel defined in the fastening portion, and a support body flow channel that is defined in the support body and supplies air supplied from the fastening portion flow channel to the laundry mounted on the support body, and a heat exchanger including a circulating flow channel that discharges air inside the door chamber to the outside of the door chamber and then guides air to the fastening portion flow channel, a fan disposed in the circulating flow channel, and an air treater that performs at least one of dehumidification and heating of air introduced into the circulating flow channel.

The laundry treating apparatus may further include a device chamber defined in the first door to define therein a space separated from the door chamber and providing a space where the heat exchanger is mounted.

The circulating flow channel may include an intake duct that guides air in the door chamber into the device chamber, a condensation duct providing a space where air discharged from the intake duct is dehumidified, a heating duct providing a space where air discharged from the condensation duct is heated, and an exhaust duct that guides air discharged from the heating duct to the fastening portion flow channel.

The air treater may be formed as a thermoelectric module including a heat absorption fin located inside the condensation duct and a heat dissipation fin located inside the heating duct.

The device chamber may be located on the door chamber.

The device chamber may include a first space separated from the door chamber via the chamber top surface and a second space extending from the first space along a height direction of the first door and separated from the door chamber via the mounting surface.

The condensation duct and the heating duct may be disposed in the first space and the exhaust duct may be disposed in the second space.

The intake duct may be located at one of a right side and a left side of the first door, the condensation duct may be located under the intake duct, and the heating duct may include a duct first body extending from the intake duct along a width direction of the first door and a duct second body extending from the duct first body along a depth direction of the first door and connected to the exhaust duct.

The exhaust duct may be formed in a shape whose cross-sectional area becomes narrower from the heating duct toward the fastening portion flow channel.

The fan may include a housing connecting the condensation duct with the heating duct, and an impeller disposed inside the housing.

The laundry treating apparatus may further include a heater disposed in one of the heating duct and the exhaust duct to heat air that has passed through the heat dissipation fin.

The laundry treating apparatus may further include a mounting body fixed to the device chamber, a duct mounting portion defined in the mounting body to support the exhaust duct, and a fastening portion mounting portion defined in the mounting body to support one end of the fastening portion inserted into the mounting hole.

The laundry treating apparatus may further include an exhaust duct connection hole extending through the fastening portion and connected to the fastening portion flow channel, and connected to the exhaust duct when the fastening portion is inserted into the fastening portion mounting portion.

The laundry treating apparatus may further include a magnet disposed in the fastening portion, and a sensor that is disposed in the mounting body and senses whether the fastening portion is inserted into the fastening portion mounting portion by sensing a magnetic force of the magnet.

The second door may include a second door body pivotably coupled to the first door, a door through-hole extending through the second door body and in communication with the door chamber, and a transparent body fixed to the second door body to close the door through-hole and made of a transparent material.

The support body may include a base where the fastening portion is fixed, and a first support and a second support fixed to the base to provide spaces for supporting the laundry and located at symmetrical points around the base, and the support body flow channel may guide air to an exhaust hole defined in at least one of the base, the first support, and the second support.

The exhaust hole may include a base exhaust hole defined in a space of the base facing the inside of the laundry mounted on the support body, a first support exhaust hole defined in a top surface of the first support in contact with the laundry mounted on the support body, and a second support exhaust hole defined in a top surface of the second support in contact with the laundry mounted on the support body.

The laundry treating apparatus may further include a first spacer disposed on the top surface of the first support to maintain a spacing between the laundry and the first support exhaust hole, and a second spacer disposed on the top surface of the second support to maintain a spacing between the laundry and the second support exhaust hole.

The present application provides a laundry treating apparatus including a cabinet including a cabinet chamber providing a space for accommodating laundry therein and a cabinet inlet allowing the cabinet chamber to be in communication with the outside, a first door that opens or closes the cabinet inlet, a door chamber defined in the first door to provide a laundry accommodation space separated from the cabinet chamber, wherein the door chamber includes a chamber top surface, a chamber bottom surface, a mounting surface connecting the chamber top surface with the chamber bottom surface, and a mounting hole defined in the mounting surface, a second door that is disposed at the first door and opens and closes the door chamber, a clothes hanger including a support body where the laundry is supported, a fastening portion detachably fixing the support body to the mounting hole, a fastening portion flow channel defined in the fastening portion, and a support body flow channel that is defined in the support body and supplies air supplied from the fastening portion flow channel to the laundry mounted on the support body, a device chamber defined in the first door and separated from the door chamber, an intake duct disposed in the device chamber and including an intake hole receiving air of the door chamber introduced thereinto, and a first communication hole and a second communication hole discharging air, an exhaust duct disposed in the device chamber and discharging air into the fastening portion flow channel, a first heat exchange duct connecting the first communication hole with the exhaust duct, a second heat exchange duct connecting the second communication hole with the exhaust duct, a first air treater that performs at least one of dehumidification and heating of air introduced into the first heat exchange duct, and a second air treater that performs at least one of dehumidification and heating of air introduced into the second heat exchange duct.

The first heat exchange duct may include a first condensation duct fixed to the first communication hole and extending along a width direction of the door chamber and a first heating duct connecting the first condensation duct with the exhaust duct and disposed in parallel with the first condensation duct, the second heat exchange duct may include a second condensation duct fixed to the second communication hole and extending along the width direction of the door chamber in a direction opposite to a point where the first condensation duct is located and a second heating duct connecting the second condensation duct with the exhaust duct and disposed in parallel with the second condensation duct, the first air treater may include a first thermoelectric module including a first heat absorption fin located inside the first condensation duct and a first heat dissipation fin located inside the first heating duct, and the second air treater may include a second thermoelectric module including a second heat absorption fin located inside the second condensation duct and a second heat dissipation fin located inside the second heating duct.

The laundry treating apparatus may further include a connecting duct disposed along a depth direction of the door chamber and connecting an outlet of the first heating duct and an outlet of the second heating duct to the exhaust duct.

The laundry treating apparatus may further include a heater disposed in the connecting duct to heat air.

### Advantageous Effects

First, the present disclosure may provide the laundry treating apparatus with the space divided into the first chamber that accommodates the laundry or the goods therein and the second chamber that accommodates the laundry or the goods therein separately from the first chamber.

Second, the present disclosure may independently adjust the temperature and the humidity of the first chamber and the temperature and the humidity of the second chamber independently of each other.

Third, the present disclosure may prevent the interference with the adjacent furniture when the door assembly is opened and closed considering the size of the second chamber disposed inside the door assembly.

Fourth, the present disclosure may provide the laundry treating apparatus in which the air circulation direction is set based on the arrangement of the hanger bar where the laundry is hung and the arrangement direction of the hanger bar, taking into account the reduction of the space for accommodating the laundry in the first chamber.

Fifth, the present disclosure may provide the door assembly that may be automatically withdrawn from the cabinet by sensing the opening of the door assembly by the user.

Sixth, the present disclosure may check the laundry or the goods accommodated in the second chamber via the front surface of the door assembly.

Seventh, the present disclosure may change the illuminance and the color of the lighting installed in the second chamber to suit the laundry or the goods.

Eighth, the present disclosure may provide the first chamber that performs the course to care for the laundry by receiving steam or hot air based on the course selected by the user, and the second chamber that constantly monitors the internal temperature and humidity of the laundry stored inside based on the settings of the user.

Ninth, the present disclosure may provide the laundry treating apparatus equipped with the treatment space (the cabinet chamber) that treats the laundry by spraying hot air and/or steam, and the showcase room (the door chamber) that is capable of displaying and treating the laundry.

Tenth, the present disclosure may provide the laundry treating apparatus that is able to adjust the temperature or the humidity of the showcase room via the single flow channel capable of the dehumidification and the blasting.

Eleventh, the present disclosure may provide the laundry treating apparatus in which the process of adjusting the temperature or the humidity of the showcase room is independent of the process in progress in the treatment space.

Twelfth, the present disclosure may provide the laundry treating apparatus equipped with the heat exchanger for adjusting the temperature or the humidity of the laundry or the accessories mounted in the showcase room.

Thirteenth, the present disclosure may provide the laundry treating apparatus equipped with the clothes hanger and the heat exchanger that may supply air into the laundry hung in the showcase room.

Fourteenth, the present disclosure may provide the laundry treating apparatus that may control the opening and closing of the flow channel that supplies air into the laundry and the flow channel that supplies air into the showcase room via the clothes hanger.

Fifteenth, the present disclosure may provide the laundry treating apparatus equipped with the hinge that prevents the opening and closing of the showcase room from interfering with the adjacent furniture or devices.

### BRIEF DESCRIPTION OF THE DRAWINGS

FIG. 1 shows an example of a laundry treating apparatus.

FIG. 2 shows an example of a first machinery room, a second machinery room, and a cabinet chamber (a treatment space) defined in a laundry treating apparatus.

FIGS. 3 and 4 show an example of a clothes hanger support.

FIG. 5 shows an example of a first door and a first door hinge.

FIGS. 6, 7, and 8 show an example of a clothes hanger and a second heat exchanger that controls a temperature or a humidity of a door chamber (a showcase room).

FIG. 9 shows another embodiment of a clothes hanger.

FIG. 10 shows another embodiment of a second heat exchanger.

FIG. 11 shows an example of a flow channel switcher.

### BEST MODEL

Hereinafter, an example of a clothes hanger and a laundry treating apparatus equipped with the clothes hanger will be described with reference to the attached drawings.

Unless otherwise specified, all terms used herein have the same general meaning as understood by a person skilled in the art to which the present disclosure pertains. When the term used herein conflicts with the general meaning of the term, the definition used herein shall apply.

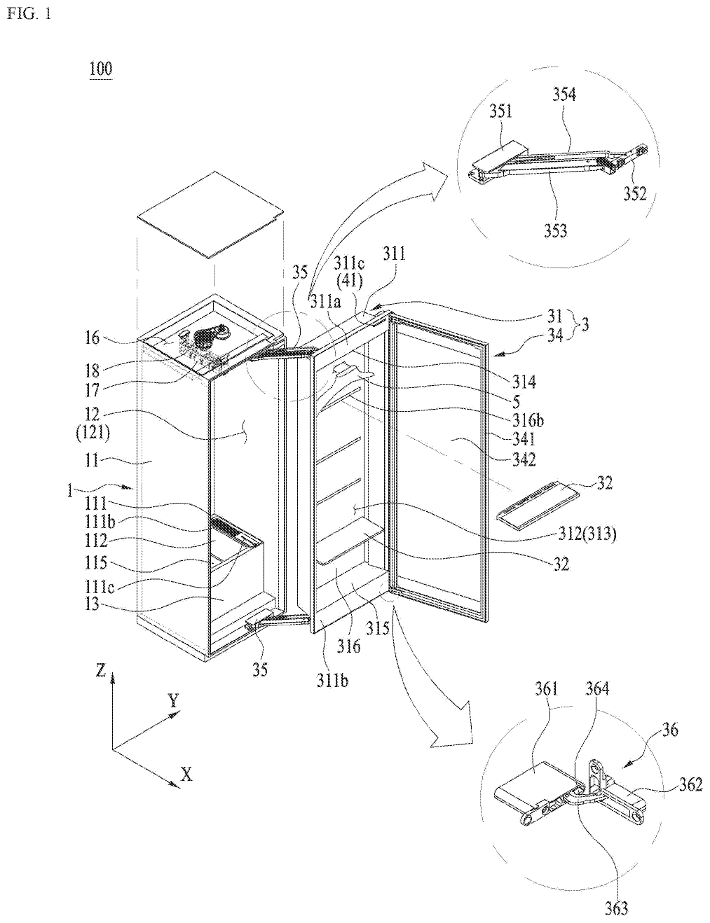

As shown in FIG. 1, a laundry treating apparatus 100 includes a main body 1 equipped with a cabinet chamber (first chamber) 12 that provides a laundry treatment space, a door 3 that is able to open or close the cabinet chamber 12 and has a door chamber 312 that provides a laundry treatment space separated from the cabinet chamber, and a clothes hanger 5 that fixes laundry to the door chamber.

Laundry treatment refers to a process of supplying air (heated air or unheated air) or moisture (heated steam or unheated steam) to the laundry to dry, remove wrinkles from, and deodorize the laundry, and the treatment space of the laundry refers to a space where the above-described treatment process is executed. The cabinet chamber 12 may be formed as a treatment space (a first treatment space) solely for treating the laundry, and the door chamber may be formed as a space (a second treatment space) for treating and displaying the laundry.

The main body 1 includes a cabinet 11 equipped with the cabinet chamber 12. The cabinet chamber 12 is in communication with the outside of the cabinet 11 via a cabinet inlet 121 defined to extend through one surface of the cabinet 11. Accordingly, a user may put the laundry (an example of an object-to-be-treated) into the cabinet chamber 12 via the cabinet inlet 121.

Referring to FIG. 1, the laundry treating apparatus 100 includes the cabinet 11 including the first inlet 121 defined in a front surface thereof, a cabinet chamber 12 located inside the cabinet 11 and accommodating the laundry or goods therein via the first inlet 121, a first machinery room (auxiliary chamber) 13 located inside the cabinet 11 at a lower side of the cabinet 11 and defining therein a space separated from the cabinet chamber 12, a door (door assembly) 3 that opens and closes the first inlet 131, a door chamber (second chamber) 312 located inside the door 3 to define therein a space separated from the cabinet chamber 12 and the first machinery room 13 and accommodating the laundry or the goods therein.

The cabinet 11 may include a cabinet top surface (a surface located in a +Z-axis direction) that forms a top surface of the cabinet 11, a cabinet rear surface (a surface located in a −X-axis direction) that forms a rear surface of the cabinet 11, and a cabinet left side surface and a cabinet right side surface (surfaces located in +Y axis/−Y axis directions) that form both side surfaces of the cabinet. The cabinet left side surface and the cabinet right side surface (not shown) will be disposed to face each other. The cabinet top surface, the cabinet left side surface, and the cabinet right side surface may be formed integrally.

The cabinet 11 includes the cabinet inlet (first inlet) 121 in the front surface. Therefore, the cabinet chamber 12 is accessible via the cabinet inlet 121. The cabinet 11 may further include the cabinet chamber 12 and the first machinery room (auxiliary chamber) 13 located under the cabinet chamber 12 therein.

The cabinet chamber (first chamber) 12 may include a first area located above the first machinery room (auxiliary chamber) 13 and a second area located in front of the first machinery room 13 and accommodating therein at least a portion of the door 3 when the door 3 closes the cabinet inlet 121.

The cabinet chamber 12 may be a space for accommodating and caring for the laundry. The cabinet chamber 12 may also be referred to as a first chamber or a treatment room. The first machinery room 13 may be a space where an electric or mechanical device for supplying hot air or steam to the cabinet chamber 12 is installed. The first machinery room 13 may also be referred to as a machinery room or an auxiliary chamber. The door chamber 312, as a space separated from the cabinet chamber 12 and the first machinery room 13, may also be referred to as an auxiliary care room, a showcase room, or a display room.

When the door 3 closes the cabinet inlet 121, at least a portion of the door chamber 312 is located inside the cabinet chamber 12, so that the door chamber 312 may be located in front of the first machinery room 13.

The door 3 may serve as a door that opens and closes the cabinet inlet 121. The user will need to open and close the door 3 to access the cabinet chamber 12.

Additionally, the door 3 may include the door chamber 312 for caring for, displaying, and storing the laundry or the goods inside the door 3. That is, the door 3 may simultaneously perform a role of a door that opens and closes the cabinet inlet 121, as well as a role of a space for caring for, storing, and displaying the laundry or the goods accommodated therein.

The door 3 may include a first door body (accommodating body) 311 including a second inlet 313 defined in a front surface thereof and defining the door chamber 312 therein, and a second door body (door of the second chamber) 342 that opens and closes the second inlet 512. After opening a second door 34, the user may accommodate the laundry or the goods in the door chamber 312 via the door inlet 313.

Considering that, when the door 3 closes the cabinet inlet 121, at least a portion of the door chamber 312 is located in the second area located closer to the cabinet inlet 121 than to a rear surface of the cabinet chamber 12 inside the cabinet chamber 12, at least a portion of the first door body (accommodating body) 312 will be located in the second area when the door 3 closes the cabinet inlet 121.

At least a portion of the door chamber 312 may be accommodated in a space between the cabinet inlet 121 and the first machinery room (auxiliary chamber) 13 when the door 3 closes the cabinet inlet 121.

Therefore, when the door 3 closes the cabinet inlet 121, the door chamber 312 may be located in front of the first machinery room 13 inside the cabinet chamber 12. Accordingly, the first machinery room 13 may be located a predetermined distance rearward from the cabinet inlet 121 to accommodate at least a portion of the door 3 inside the cabinet chamber 12.

As shown in FIG. 1, there may be a step caused by the first machinery room 13 that forms the bottom surface of the cabinet chamber 12.

In one example, the door 3 may hang the clothes hanger 5 therein to accommodate the laundry in the door chamber 312. Alternatively, a first door body (accommodating body) 311 that is detachably disposed in the door chamber 312 to support laundry or the goods accommodated in the door chamber 312 may be further included.

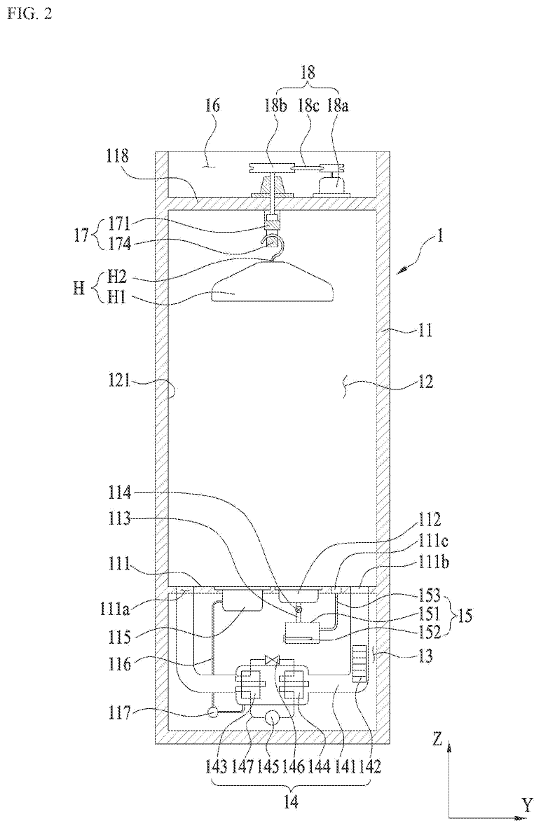

As shown in FIG. 2, the second door 34 may be made of a material that allows the interior of the door chamber 312 to be checked. In other words, at least a portion of the second door 34 may be made of a material that allows visible light to pass therethrough.

When the second door 34 is opened, the door 3 may accommodate the laundry or the items in the door chamber 312 via the door inlet 313.

Therefore, a front surface of the second door 34 may be made of a transparent material. The front surface of the second door 34 may be made of a completely transparent material, but alternatively, may also be made of a translucent material.

To this end, the second door 34 may include an opening (not shown) in which at least a portion of the front surface is opened, and may include a second door body (door frame) 341 forming a frame of the second door 34 and a transparent body (door window) 342 surrounded by the second door body 341 and coupled to the second door body 341.

At least a portion of the transparent body 342 may be made of a transparent material or may also be made of a translucent material. Additionally, the transparent body 342 may be transparent but may have a color.

The second door body 341 may be disposed to surround an outer surface of the transparent body 342. In contrast, the second door body may be coupled to a rear surface of the transparent body 342, so that only the transparent body 342 may be exposed forward of the second door body 341.

In one example, the laundry treating apparatus 100 may further include an opening/closing driver 170 that pushes the door 3 to automatically open the door 3. The opening/closing driver 170 may be disposed between a cabinet top surface 112 and a first chamber top surface 132 forming a top surface of the cabinet chamber 12.

Referring to FIG. 2, the opening/closing driver 170 may be coupled to a location under the cabinet top surface 112. Alternatively, the opening/closing driver 170 may be disposed under the first chamber top surface 132.

One opening/closing driver 170 may be sufficient, but there may be a plurality of opening/closing drivers. The opening/closing driver 170 may be disposed not only between the cabinet top surface 112 and the first chamber top surface 132, but also on the first chamber bottom surface 135 that forms the bottom surface of the first chamber. Alternatively, the opening/closing driver 170 may be located between the first chamber bottom surface 135 and the bottom surface of the cabinet 11.

The reason why the opening/closing driver 170 includes the plurality of opening/closing drivers is to push the door 3 from the top and the bottom to prevent the door 3 or a hinge structure that couples the door 3 to the cabinet from being deformed as a force is concentrated on one side or an unnecessary torque is generated.

As shown in FIG. 2, the main body 1 includes a first partition 111 and a second partition 118 that divide an internal space of the cabinet 11.

The first partition 111 may be a means of dividing the inside of the cabinet into the first machinery room 13 and the cabinet chamber 12, and the second partition 118 may be a means of dividing the inside of the cabinet into a second machinery room 16 and the cabinet chamber 12.

The first machinery room 13 may be defined as a space located in a lower portion of the cabinet chamber 12 and where a supply 14 and 15 is installed, and the second machinery room 16 may be defined as a space located in an upper portion of the cabinet chamber 12 and where a driver 18 is installed. The first partition 111 will form a bottom surface of the cabinet chamber 12 and a top surface of the first machinery room 13 and the second partition 118 will form a top surface of the cabinet chamber 12 and a bottom surface of the second machinery room 16.

The supply 14 and 15 is a means for supplying at least one of air and moisture to the cabinet chamber 12. FIG. 2 shows a case in which the supply includes both of a first supply 14 that supplies air to the cabinet chamber 12 and a second supply 15 that supplies moisture to the cabinet chamber 12 as an example.

The first supply 14 may supply heated air (hot air) to the cabinet chamber 12 or may supply unheated air to the cabinet chamber 12. FIG. 2 shows the former case as an example.

The second supply 15 may supply heated vapor (steam) or unheated vapor (mist or the like) to the cabinet chamber 12. FIG. 2 shows the second supply 15 that supplies heated vapor to the cabinet chamber 12 as an example.

The main body 1 may have a connection hole 111a, an air supply hole 111b, and a moisture supply hole 111c that extend through the first partition 111 and connect the cabinet chamber 12 with the first machinery room 13.

In this case, the first supply 14 may include a duct 141 that connects the connection hole 111a with the air supply hole 111b to form an air flow path, a duct fan 142 that allows air to flow along the duct 141, and a heat exchanger (first heat exchanger) that sequentially dehumidifies and heats air introduced into the duct 141.

The first heat exchanger (cabinet heat exchanger) 143, 144, 145, 146, and 147 includes a heat absorber 143 that absorbs heat from air introduced into the duct 141 and condenses air, and a heater 144 that heats air by supplying heat to air that has passed through the heat absorber. The heat absorber 143 and the heater 144 are connected to each other via a refrigerant pipe 147 that forms a circulating flow channel of a refrigerant, and the refrigerant pipe 147 includes a compressor 145 that allows the refrigerant to flow along the refrigerant pipe, and a pressure regulator 146 that adjusts a pressure of the refrigerant circulating along the refrigerant pipe.

The second supply 15 may include a storage 151 that is disposed in the first machinery room 13 and stores water therein, a steam heater 152 that is disposed inside the storage and heats water, and a supply pipe 153 that guides steam inside the storage 151 to the moisture supply hole 111c. The steam heater 152 may be formed as an electric resistance element (heating element) that generates heat when power is supplied.

The second supply 15 receives water via a water supply tank 112, and condensate discharged from the heat absorber 143 is stored in a drain tank 115.

The water supply tank 112 and the drain tank 115 may be detachably fixed to the first partition 111. In this case, the water supply tank 112 may be connected to the storage 151 via a water supply flow channel 113, and the water supply flow channel 113 may have a water supply valve 114. The drain tank 115 may be connected to the duct 141 via a drain flow channel 116, and the condensate stored inside the duct 141 may flow to the drain tank 115 via a pump 117.

The cabinet chamber 12 may have a clothes hanger controller 17 and 18 supporting a clothes hanger (cabinet clothes hanger) H.

The cabinet clothes hanger H may include a hanging portion H1 on which the laundry is supported, and a fastening hook H2 fixed to the hanging portion. The clothes hanger controller 17 and 18 may include a clothes hanger support 17 on which the fastening hook H2 is supported, and the driver 18 that causes the clothes hanger support 17 to move inside the cabinet chamber 12.

The clothes hanger support 17 may be located in the cabinet chamber 12, and the driver 18 may be disposed in the second machinery room 16.

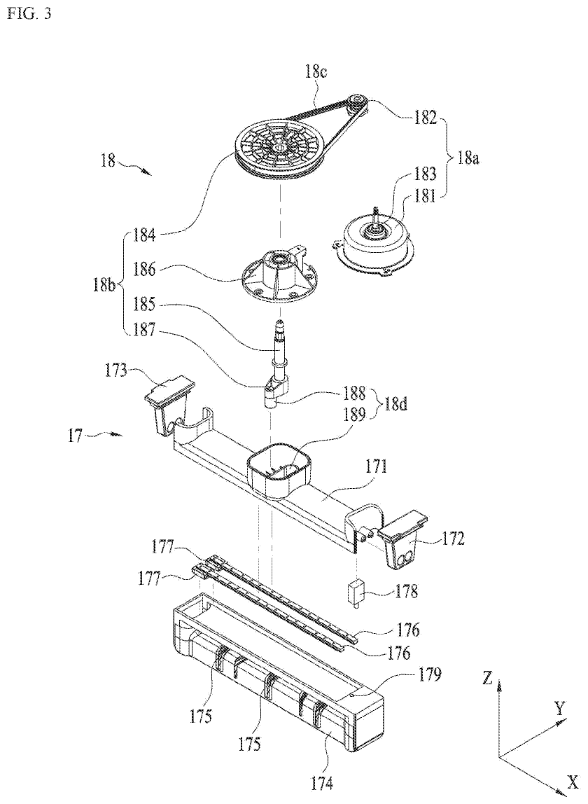

As shown in FIG. 3, the clothes hanger support portion 17 may include a first body 171 that vibrates by the driver 18, and a second body 174 coupled to the first body 171 so as to be extended toward the cabinet inlet 121.

The first body 171 may be formed as a bar parallel to a depth direction of the cabinet chamber 12 (an X-axis direction). The first body 171 may be connected to the second partition 118 via a first connecting body 172 and a second connecting body 173. That is, the first connecting body 172 may connect one end of the first body 171 with the second partition 118 and the second connecting body 173 may connect the second partition 118 with the other end of the first body 171.

The first connecting body 172 and the second connecting body 173 may be made of an elastic body such as rubber such that the first body 171 may move along the depth direction of the cabinet chamber 12 (the X-axis direction) when the driver 18 is operated.

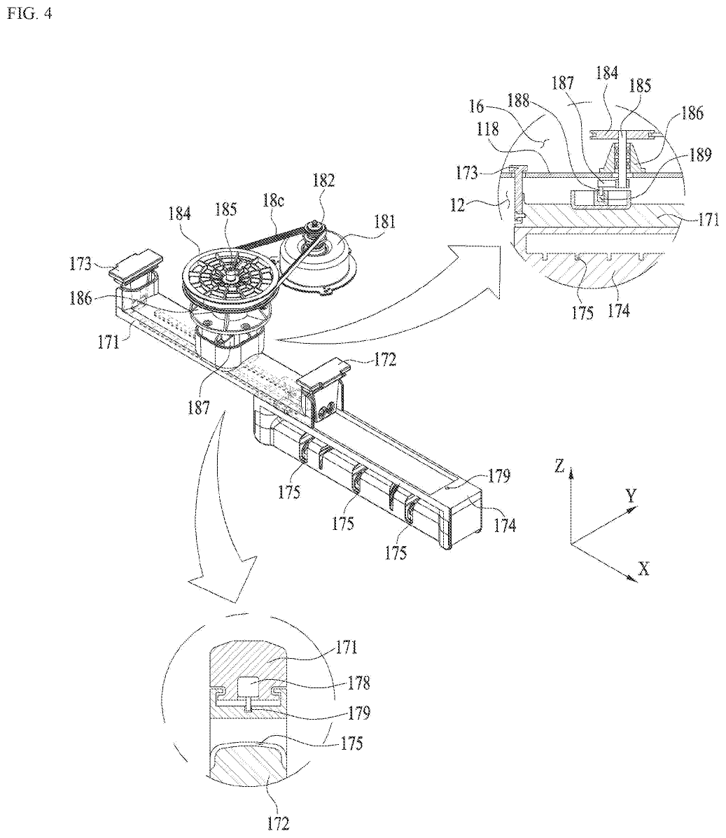

The second body 174 may be coupled to the first body 171 via a body guide 176 and 177. The body guide may include a rail 176 fixed to the first body 171 and a block 177 fixed to the second body 174. The block 177 is coupled to the rail 176 so as to move along the rail 176. Therefore, as shown in FIG. 4, the second body 174 may be extended out of the cabinet chamber 12 (outside the cabinet chamber) by the body guide 176 and 177. When the second body 174 is constructed to be extended out of the cabinet chamber 12, it is convenient in fixing the cabinet clothes hanger H to the second body 174 or separating the same from the second body 174.

Like the first body 171, the second body 174 may be formed as a bar parallel to the depth direction of the cabinet chamber 12 (the X-axis direction), and a hook accommodating groove 175 in which the fastening hook H2 is accommodated may be defined in a top surface of the second body 174.

When the first body 171 and the second body 174 are disposed parallel to the depth direction of the cabinet chamber 12, the air supply hole 111b defined in the first partition 111 may be defined as a slit parallel to the depth direction of the cabinet chamber 12. This is to ensure that air is supplied to a wide surface of the laundry. For the same reason, the connection hole 111a and the moisture supply hole 111c may also be defined as slits parallel to the depth direction of the cabinet chamber 12.

As shown in FIG. 3, the driver 18 may include a driving member 18a fixed to the second machinery room 16, a driven member 18b connected to the driving member 18a via a belt 18c, and a converting member 18d that transmits a rotational movement of the driven member 18b to the first body 171.

FIG. 3 is an exploded view of the driver 18 and the clothes hanger support 17 disposed in the cabinet chamber 12. The clothes hanger support 17 may include a second body (hanger body) 174 disposed along the front and rear direction of the cabinet 11 and hanging the laundry thereon, and the first body (hanger support) 171 disposed along the front and rear direction of the cabinet 11 and located on the second body 174 to mount the second body 174.

The driver 18 may be located in the space (second machinery room) 16 between the top surface of the cabinet chamber 12 and the top surface of the cabinet 11 to prevent exposure to the user and failure caused by steam and hot air supplied to the cabinet chamber (first chamber) 12.

Additionally, the driver 18 may be supported by the hanger frame (not shown). The hanger frame may also be located in the second machinery room 16, and both ends of the hanger frame may be coupled to a cabinet frame (not shown) that forms a skeleton of the cabinet 11 or the cabinet 11. This is to prevent the vibration of the driver 18 from being transmitted into the cabinet chamber 12.

As shown in FIG. 4, the driving member 18a may be composed of a motor 181 fixed to the second machinery room 16 and a driving pulley 182 fixed to a rotation shaft (motor shaft) 183 of the motor.

The driven member 18b may include a rotation shaft 185 disposed to extend through the second partition 118, a driven pulley 184 fixed to one end of the rotation shaft and located in the second machinery room 16, and an arm 187 fixed to the other end of the rotation shaft and located in the cabinet chamber 12. To support the rotation shaft 185, the second partition 118 may have a shaft support (bearing housing) 186.

The driving pulley 182 and driven pulley 184 are connected to each other via the belt 18c. However, when the driving pulley is formed as a driving gear fixed to the motor shaft 183 and the driven pulley is formed as a driven gear fixed to the rotation shaft 185 and connected to the driving gear, the belt may be omitted.

The converting member 18d may include a slot 189 defined in the first body 171, and a slot fastening portion 188 disposed at a free end of the arm 187 and inserted into the slot 189.

The slot 189 may be defined parallel to the width direction (a Y-axis direction, a direction perpendicular to the first body) of the cabinet chamber. A length of the slot 189 may be set to be equal to or greater than a diameter of a rotation trajectory formed by the slot fastening portion 188. In this case, when the driver 18 operates, the first body 171, the second body 174, and the cabinet clothes hanger H will perform a reciprocating movement along the depth direction of the cabinet chamber 12 (the X-axis direction).

When the driver 18 operates while the second body 174 is extended out of the cabinet chamber 12, the second body 174 may be damaged. To prevent such risk, the clothes hanger controller may be further equipped with an extension sensor that senses whether the second body 174 is extended.

FIG. 4 shows a case in which the extension sensor is composed of a sensor 178 fixed to the first body 171 and an actuator 179 that is disposed on the second body 174 to control operation of the sensor 178 as an example.

The sensor 178 may be formed as a contact sensor that generates different control signals depending on a location of a sensor bar, and the actuator 179 may be formed as a groove in which the sensor bar is accommodated. In this case, a free end of the sensor bar will be inserted into the groove when the second body 174 moves into the cabinet chamber 12, and the free end of the sensor bar will be removed from the groove and the sensor 178 will generate a control signal accordingly when the second body 174 is extended out of the cabinet chamber 12, so that the controller (not shown) will be able to sense a location of the second body 174.

As shown in FIG. 1, the cabinet chamber 12 is opened or closed by the door 3.

The door 3 may include a first door 31 that is fixed to the cabinet 11 via a first hinge 35 and controls the opening and closing of the cabinet inlet 121, and a second door 34 that is fixed to the first door 31 via a second hinge 36 and controls the opening and closing of the door chamber 312 defined in the first door.

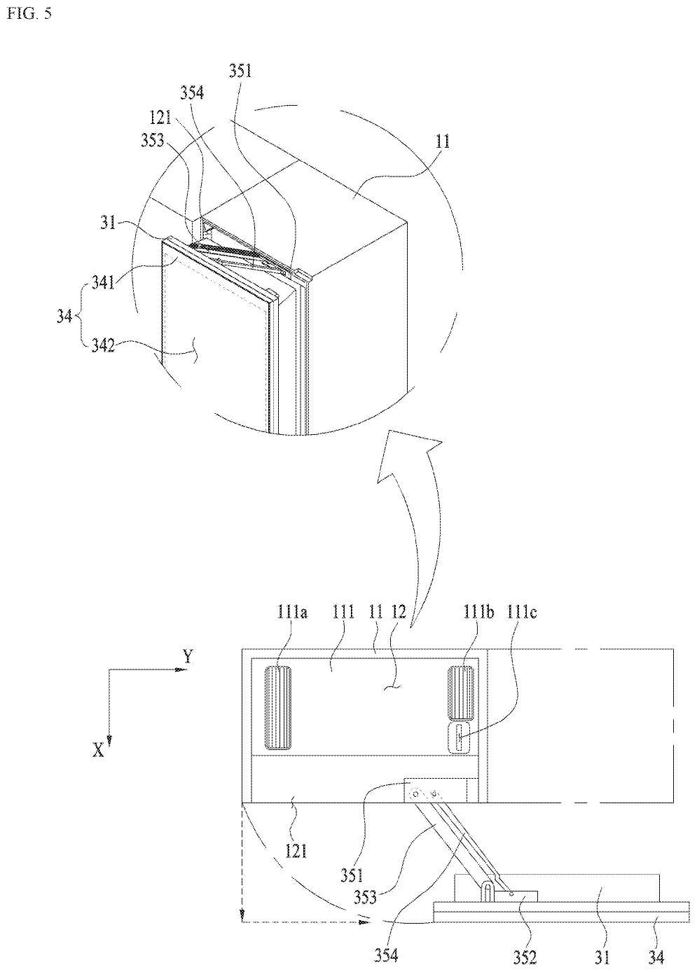

As shown in FIG. 5, the first hinge 35 may be formed to execute a motion in which a first motion in which the first door 31 moves forwardly of the cabinet 11 (the X-axis direction) and a second motion in which the first door 31 moves in the width direction of the cabinet 11 (the Y-axis direction) are combined with each other.

Constructing the first hinge 35 such that the first door 31 executes the motion that is the combination of the first motion and the second motion considers a case in which another object (a closet or other home appliance) is disposed on a side of the main body 1.

For the first door 31 to pivot, a space where a corner of the first door may pivot is required at the side surface of the cabinet 11. Accordingly, when the first door 31 is not constructed to execute the first and second motions, an empty space is inevitably defined between the side surface of the cabinet 11 and a side surface of the object, which is not desirable in terms of efficient use of an indoor space or an interior design.

The motion (the combination of the first motion and the second motion) of the first door 31 may be implemented with the first hinge 35 of the structure shown in FIG. 5. That is, the first hinge 35 may include a first fixed body 351 fixed to the cabinet 11, a second fixed body 352 fixed to the first door 31, and a first connection bar (first hinge first connection bar) 353 and a second connection bar (first hinge second connection bar) 354 that connect the first fixed body with the second fixed body.

The second hinge 36 may have the same structure as the first hinge 35 or may have a different structure from the first hinge.

FIG. 1 shows a case in which the second hinge 36 is composed of a first door-fixed body 361 fixed to the first door 31, a second door-fixed body 362 fixed to the second door 36, and a first connection bar (second hinge first connection bar) 363 and a second connection bar (second hinge second connection bar) 364 that connect the two fixed bodies 361 and 362 to each other is shown as an example.

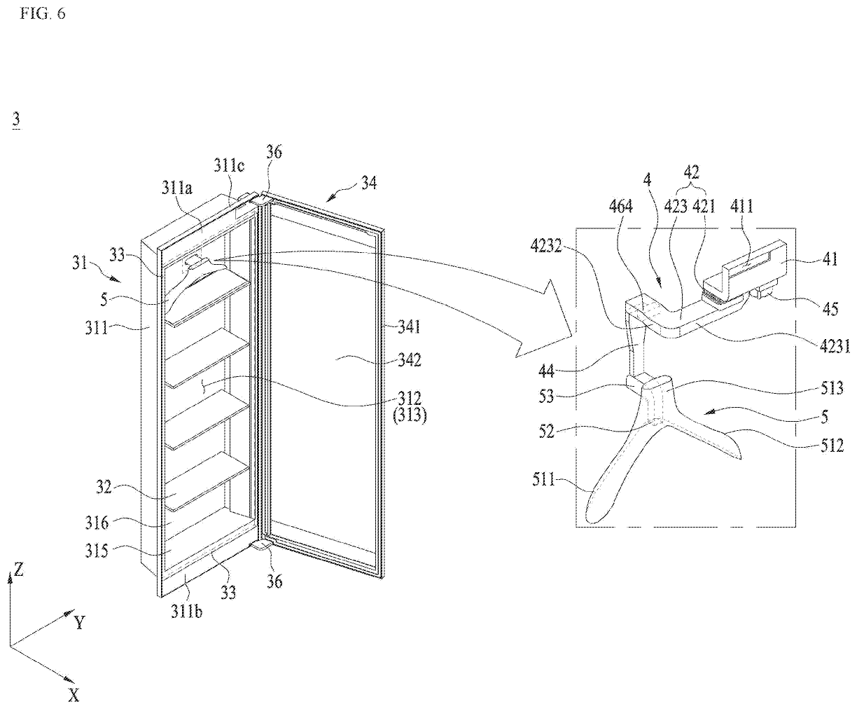

As shown in FIG. 6, the first door 31 includes a first door body 311 having the door chamber 312. The door chamber 312 may be formed as a space where one surface of the first door body 311 (a front surface of the first door body) is bent concavely inward of the cabinet chamber 12.

That is, the door chamber 312 may be defined in the first door body 311 and may be defined as a treatment space and a showcase room for the laundry located inside the cabinet chamber 12. This is to allow the door chamber 312 to be located inside the cabinet chamber 12 when the first door 31 closes the cabinet inlet 121. This is because, when the door chamber 312 is located inside the cabinet chamber 12, effects of not only minimizing heat loss of the cabinet chamber 12 via the door 3 but also minimizing heat loss inside the door chamber 312 may be expected.

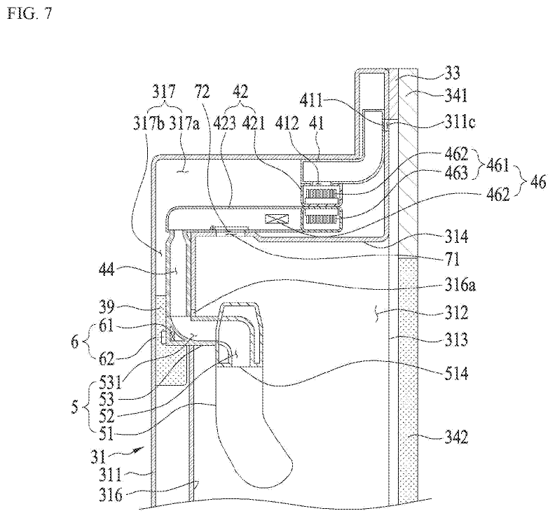

The door chamber 312 may have various shapes. FIG. 6 shows a case in which the door chamber 312 is formed in a hexahedral shape as an example. As shown in FIGS. 6 and 7, the door chamber 312 is formed via a chamber top surface 314, a chamber bottom surface 315, a mounting surface 316, and two chamber side surfaces, and the door inlet 313 is defined in one surface of the door chamber 312.

FIGS. 6 and 7 show a case in which the door inlet 313 is defined in a front surface of the first door body 311 as an example. In this case, the mounting surface 316 connects a rear end of the chamber upper surface 314, a rear end of the chamber bottom surface 315, and rear ends of the two chamber side surfaces to each other, but faces the door inlet 313.

As shown in FIG. 7, the first door body 311 may have a device chamber 317 located on the door chamber 312. FIG. 7 shows a case in which the device chamber 317 is composed of a first space 317a that is separated from the door chamber 312 via the chamber top surface 314, and a second space 317b that extends along a height direction of the first door 31 from the first space 317a and is separated from the door chamber 312 via the mounting surface 316 as an example.

As shown in FIG. 6, the second door 34 may include the second door body 341 connected to the first door body 311 via the second hinge 36, and the transparent body 342 disposed in the second door body 341.

The transparent body 342 is a means of allowing the door chamber 312 to be viewed from the outside. The second door body 341 may have a door through-hole in a shape corresponding to an edge of the door inlet 313, and the transparent body 342 may be made of a transparent glass, a transparent plastic material, or the like that is fixed to the second door body 341 and closes the door through-hole.

As shown in FIG. 1, the mounting surface 316 may have a shelf 32 that provides a space for supporting the laundry, bags, or the accessories.

The shelf 32 is preferably detachable from the mounting surface 316. As will be described later, the clothes hanger 5 is detachably fixed to the mounting surface 316, which is to prevent the laundry hung on the clothes hanger 5 from interfering with the shelf 32. To this end, the mounting surface 316 may have a shelf support 316b in which the shelf 32 is detachably fixed. The shelf support 316b may be defined as a slot-shaped groove defined along a width direction of the door chamber 312 (the Y-axis direction).

As shown in FIG. 6, a sealing portion 33 surrounding the door inlet 313 may be further disposed on the front surface of the first door body 311.

The front surface of the first door body may be composed of an upper front surface (first front surface) 311a located on the door inlet 313, a lower front surface (second front surface) 311b located beneath the door inlet, and a left front surface and a right front surface located on both sides of the door inlet. The sealing portion 33 may be formed as a square ring-shaped rubber fixed to the upper front surface 311a, the left front surface, the right front surface, and the lower front surface 311b.

The sealing portion 33 is a means to block air or moisture inside the door chamber 312 from being discharged to the outside toward a space between the first door body 311 and the second door body 341 when the door inlet 313 is closed by the second door 34. Additionally, the sealing portion 33 may serve as a means to maintain a spacing between the front surface of the first door body 311 (the surface where the door inlet is defined) and the second door body 341.

The device chamber 317 has a second heat exchanger (door heat exchanger) 4. The second heat exchanger 4 is a means to supply air (heated air or unheated air) to a flow channel defined inside the clothes hanger 5.

The clothes hanger 5 may include a support body 51 on which the laundry is supported, and a fastening portion 53 that detachably fixes the support body to the mounting hole.

The support body 51 may include a base 513 to which the fastening portion 53 is fixed, and a first support 511 and a second support 512 that are fixed to the base 513 to provide spaces for supporting the laundry and are located at points symmetrical to each other about the base 513, respectively. In this case, the fastening portion 53 may be formed as a bar protruding from the base 513 along a depth direction of the door chamber 312.

Additionally. FIG. 6 may include another embodiment in which the clothes hanger 5 is mounted on a clothes hanger mounting portion 39. The second door 34 may be made of a transparent material, so the user may check the door chamber 312 without opening the second door 34. Referring to FIG. 6, the door 3 may further include the shelf 32 on which the laundry or the goods may be placed in the door chamber 312.

The laundry or the goods may be stored on the shelf. The shelf 32 may include a plurality of shelves. Additionally, because the shelf 32 is detachable from the shelf mounting portion, a spacing between the plurality of shelves may be adjusted based on a size of the goods being displayed.

As shown in FIG. 7, the fastening portion 53 may be detachably fixed to the clothes hanger mounting portion 39 disposed in the device chamber 317. In this case, the mounting surface 316 may have a mounting hole 316a that extends through the mounting surface and is in communication with the clothes hanger mounting portion 39.

The fastening portion 53 may have a fastening portion flow channel 531 connected to the second heat exchanger 4, and a support body flow channel 52 that supplies air supplied from the fastening portion flow channel 531 to the laundry hung on the support body 51 may be disposed inside the support body 51.

The fastening portion flow channel 531 may be formed as a flow channel defined along the depth direction of the door chamber (the X-axis direction) inside the fastening portion 53, and the support body flow channel 52 may be formed as a flow channel that connects the fastening portion flow channel 531 with an exhaust hole defined in the base 513.

FIG. 7 shows a case in which the exhaust hole is defined as a base exhaust hole 514 defined in a space facing the inside of the laundry hung on the support body of the base. In this case, the support body flow channel 52 may extend from the fastening portion flow channel 531, but may be bent toward the bottom surface (chamber bottom surface) 315 of the door chamber 312.

As shown in FIG. 6, the second heat exchanger 4 may include a circulating flow channel 41, 42, and 44 that discharges air inside the door chamber 312 to the outside of the door chamber and then guides air to the fastening portion flow channel 531, a fan 45 disposed in the circulating flow channel, and an air treater 46 that performs at least one of dehumidifying and heating of air introduced into the circulating flow channel.

As shown in FIG. 7, the circulating flow channel may include an intake duct 41 that guides air of the door chamber 312 into the device chamber 317, a heat exchange duct 42 that provides a space for dehumidifying and heating air discharged from the intake duct (a space for the air treater to be mounted), and an exhaust duct 44 that guides air discharged from the heat exchange duct 42 to the fastening portion flow channel 531.

The intake duct 41, as a duct fixed inside the device chamber 317, may have various structures depending on a shape of the device chamber 317. FIG. 7 shows a case in which the intake duct 41 is composed of an intake duct first body defined along the height direction of the first door body (the Z-axis direction) and parallel to a front surface 311a of the first door body, and an intake duct second body extending from the intake duct first body and extending along the depth direction of the door chamber 312 (the X-axis direction).

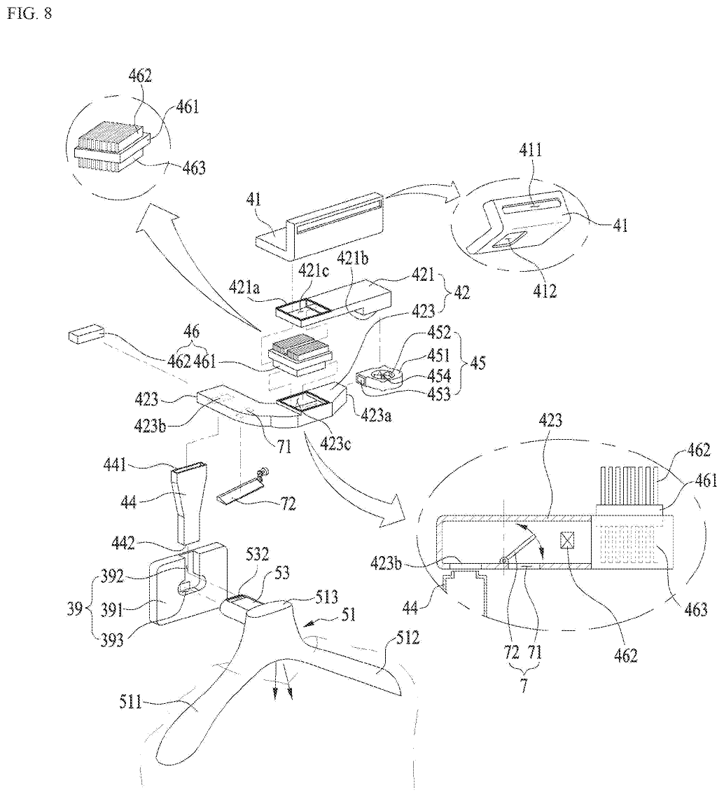

As shown in FIG. 8, a front surface of the intake duct 41 (a surface facing the front surface of the first door) may have an intake hole 411 into which air is introduced, and a bottom surface of the intake duct 41 (a surface facing the chamber top surface) may have a communication hole 412 connected to the heat exchange duct 42.

When the intake duct 41 is fixed inside the device chamber 317, the intake hole 411 may be connected to a front surface through-hole 311c defined in the first front surface 311a of the first door body (see FIG. 7).

The heat exchange duct 42 may include a condensation duct 421 that provides a space for dehumidifying air discharged from the communication hole 412, and a heating duct 423 that provides a space in which air discharged from the condensation duct is heated.

The fan 45 may connect the condensation duct 421 with the heating duct 423. That is, the fan 45 may include a housing 451 connecting the condensation duct 421 with the heating duct 423 and an impeller 454 disposed inside the housing.

The housing 451 may include a housing inlet 452 connected to the condensation duct 421 and a housing outlet 453 connected to the heating duct 423. When the condensation duct 421 and the heating duct 423 are in a stacked structure along the height direction of the device chamber 317 (a volume of the device chamber is minimized), the housing inlet 452 may be defined as a through-hole defined in a top surface of the housing 451, and the housing outlet 453 may be defined in a side surface of the housing 451.

The impeller 454, as a means for allowing air introduced into the housing inlet 452 to flow to the housing outlet 453, may be rotated by a motor fixed to the outside of the housing 451.

The condensation duct 421 may include a condensation duct inlet 421a connected to the communication hole 412 and a condensation duct outlet 421b connected to the housing inlet 452, and the heating duct 423 may include a heating duct inlet 423a connected to the housing outlet 453 and a heating duct outlet 423b connected to the exhaust duct 44.

The air treater 46 may include a heat exchanger 461 located between the condensation duct 421 and the heating duct 423 (the condensation duct, the heat exchanger, and the heating duct are in the stacked structure along the height direction of the device chamber, designed to minimize the volume of the device chamber). The heat exchanger 461 may be formed as any device as long as it may remove moisture from air introduced into the condensation duct and heat air introduced into the heating duct. FIG. 8 shows a case in which the heat exchanger 461 is formed as a thermoelectric module (thermoelectric element) as an example.

A heat exchanger first mounting hole 421c may be defined in a bottom surface of the condensation duct 421, and a heat exchanger second mounting hole 423c may be defined in a top surface of the heating duct 423. In this case, the heat exchanger 461 may include a heat absorption fin 462 inserted into the heat exchanger first mounting hole 421c and located inside the condensation duct 421, and a heat dissipation fin 463 inserted into the heat exchanger second mounting hole 423c and located inside the heating duct 423.

The air treater 46 may further include a heater 464 that heats air that has passed through the heat dissipation fin 463. The heater 464 may be disposed in the heating duct 423 or in the exhaust duct 44.

The exhaust duct 44 is a flow channel connecting the heating duct outlet 423b with the fastening portion flow channel 531, and the exhaust duct 44 includes an exhaust duct inlet 441 connected to the heating duct outlet 423b and an exhaust duct outlet (exhaust hole) 443 connected to the fastening portion flow channel 531.

As shown in FIG. 7, the intake duct 41, the condensation duct 421, and the heating duct 423 are disposed in the first space 317a, and the exhaust duct 44 may be defined in the second space 317b along the height direction of the first door body 311.

To dehumidify and heat air, it is necessary to ensure sufficient lengths of the condensation duct and the heating duct. When the ducts 41, 421, 423, and 44 are disposed in the first space 317a and the second space 317b in a divided manner as described above, a sufficient flow channel for heat exchange may be formed while minimizing the volume of the door 3.

For the same reason as described above, as shown in FIG. 6, the intake duct 41 may be located at one of right and left sides of the first door body 311 and the condensation duct 421 may be located under the intake duct 41. In this case, the heating duct 423 may include a duct first body 4231 extending from the intake duct 41 along the width direction of the first door body 311, and a duct second body 4232 extending from the duct first body 4231 along the depth direction of the first door body (the X-axis direction). The heating duct inlet 423a and the heat exchanger second mounting hole 423c may be defined in the duct first body 4231, and the heating duct outlet 423b may be defined in the duct second body 4232.

To increase a flow rate of air supplied to the fastening portion flow channel 531, a flow channel cross-sectional area of the exhaust duct 44 is preferably in a shape that becomes narrower toward the fastening portion 53 from the heating duct 423.

As previously mentioned, the device chamber 317 has the clothes hanger mounting portion 39. The clothes hanger mounting portion 39 may not only serve to fix the fastening portion 53, but also serve to maintain coupling of the exhaust duct 44 and the fastening portion flow channel 531.

That is, as shown in FIG. 8, the clothes hanger mounting portion 39 may include a mounting body 391 fixed to the second space 317b of the device chamber, a duct mounting portion 392 defined in the mounting body 391 to support the exhaust duct 44, and a fastening portion mounting portion 393 defined in the mounting body 391 to support one end of the fastening portion 53 inserted into the mounting hole 316a. The duct mounting portion 392 and the fastening portion mounting portion 393 may be defined as grooves where the mounting body 391 is concavely bent and connected to each other.

When the fastening portion 53 is inserted into the mounting hole 316a of the door chamber 312, an outlet 442 of the exhaust duct may be connected to an exhaust duct connection hole 532 defined in the fastening portion 53. The exhaust duct connection hole 532 may be defined as a through-hole that extends through the fastening portion 53 and is connected to the fastening portion flow channel 531.

The laundry treating apparatus 100 may include a mounting sensor 6 that senses whether the clothes hanger 5 is mounted in the door chamber 312. As shown in FIG. 7, the mounting sensor 6 may include a magnet 61 disposed in the fastening portion 53 and a magnetic force sensor 62 disposed in the mounting body 391 to sense a magnetic force of the magnet.

When the mounting sensor 6 is disposed, the laundry treating apparatus 100 may control the second heat exchanger such that the second heat exchanger 4 operates only when the clothes hanger 5 is mounted in the door chamber 312.

The laundry treating apparatus 100 having the above-described structure may treat the laundry inside the cabinet chamber 12 via the first supply 14 and the second supply 15. Additionally, the laundry treating apparatus 100 may adjust humidity and temperature inside the door chamber 312 by operating the second heat exchanger 4. The user may check the laundry hung on the clothes hanger 5 or the items (the accessories or the like) mounted on the shelf 32 from the outside via the transparent body 342.

The laundry treating apparatus 100 may control air circulation inside the door chamber 312 and the temperature and the humidity inside the door chamber 312 by controlling the operation of the fan 45, the heat exchanger 461, and the heater 464.

That is, the laundry treating apparatus 100 may operate only the fan 45 to execute a process of circulating air inside the door chamber 312. Additionally, the laundry treating apparatus 100 may operate the fan and the air treater 46 to execute a process of controlling the humidity or the temperature inside the door chamber 312. The process of controlling the humidity or the temperature of the door chamber 312 may operate only one of the heat exchanger 461 and the heater 464 or operate both the heat exchanger 461 and the heater 464.

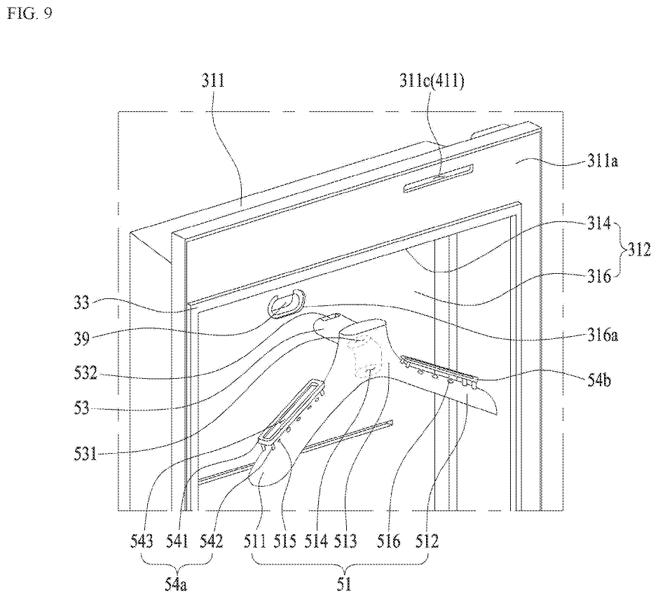

FIG. 9 shows another embodiment of the clothes hanger 5 disposed in the door chamber 312.

The clothes hanger 5 according to the present embodiment includes the base exhaust hole 514 that is the exhaust hole supplying air to the laundry defined in the base 513, a first support exhaust hole 515 defined in a top surface of the first support 511, and a second support exhaust hole 516 defined in a top surface of the second support 512.

The first support exhaust hole 515 is a means to supply air to an area of the laundry in contact with the first support 511 (a shoulder of the laundry), and the second support exhaust hole 516 is a means to supply air to an area of the laundry in contact with the second support 512.

To minimize an increase in a flow channel resistance caused by the laundry blocking the first support exhaust hole 515 and the second support exhaust hole 516, a spacer 54a and 54b may be disposed on the first support 511 and the second support 512.

That is, the spacer may include a first spacer 54a disposed on the top surface of the first support 511 and maintaining a spacing between the laundry and the first support exhaust hole 515, and a second spacer 54b disposed on the top surface of the second support 512 and maintaining a spacing between the laundry and the second support exhaust hole 516.

Each spacer 54a and 54b may include a spacer body 541 on which the laundry is supported, a fixing portion 542 that fixes the spacer body to the support body 51, and a through-hole 543 that extends through the spacer body and allows air to pass therethrough.

Referring to FIG. 9, another example of the clothes hanger (hanger assembly) 5 mounted on the clothes hanger mounting portion may be disclosed. The clothes hanger 5 may include a hanger housing that forms an outer appearance and a ring that mounts the hanger housing on the hanger mounting portion.

The hanger housing may include a central support located at a center of the hanger housing and an extension support that extends from the central support to both sides and supports the laundry.

A top surface and side surfaces of the extension support and a bottom surface of the hanger housing, that is, bottom surfaces of the central support and the extension support, may include a steam supply hole that may supply steam to the laundry hung on the clothes hanger 5 and an air supply hole that may supply air.

The steam supply hole 836 and the air supply hole 834 may include a plurality of steam supply holes and a plurality of air supply holes, respectively. Because it is hygienic that steam and air must have different flow channels, the steam supply hole 836 and the air supply hole will not be in communication with each other.

Referring to FIG. 9, the plurality of air supply holes and the plurality of steam supply holes are arranged along an extension direction of the extension support on the top and side surfaces of the extension support and the bottom surface of the hanger housing. Accordingly, the plurality of air supply holes and the plurality of steam supply holes may be arranged to face each other along the front and rear direction of the hanger housing.

The laundry hanger may further include a steam unit that is located inside the hanger housing, generates steam, and supplies steam to the laundry via the steam supply hole.

The clothes hanger 5 may further include a hanger fan that is located in the hanger housing, sucks air from the outside of the hanger housing, and supplies air via the air supply hole.

Specifically, an inlet hole (not shown) defined through a front surface of the hanger housing and the hanger fan positioned in the inlet hole to suck air may be further included.

The clothes hanger (laundry hanger) 5 may further include a hanger heater (not shown) that is located at the rear of the hanger fan and heats sucked air. Sucked air may be heated via the hanger heater and then supplied via the air supply hole.

Therefore, the air supply hole will able to supply hot air or air at a room temperature.

The steam unit and the hanger fan may be located at a center of the hanger housing. This is to maintain a balance of the clothes hanger 5 by reflecting weights of the steam unit and the hanger fan.

The clothes hanger 5 may further include a spacer to prevent the laundry hung on the clothes hanger 5 from being in contact with the extension support. The spacer may define a predetermined space between the laundry and the extension support to prevent the air supply hole and the steam supply hole located in the extension support from being unintentionally blocked by being in contact with the laundry.

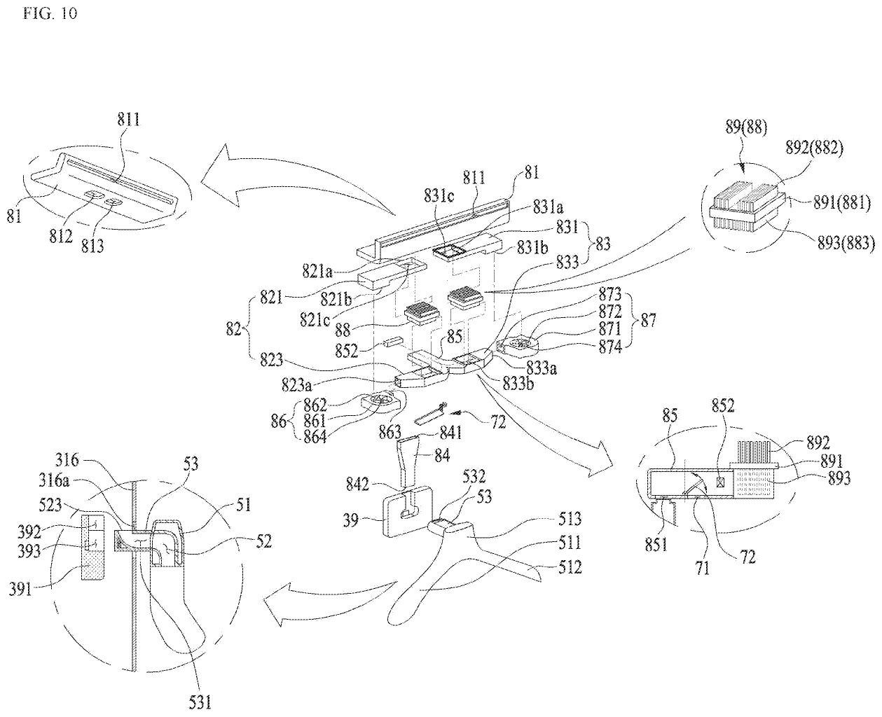

FIG. 10 shows another embodiment of a second heat exchanger.

A second heat exchanger 8 in FIG. 10 is distinguished from the second heat exchanger 4 in FIG. 8 in that there are two heat exchange ducts 82 and 83, and a remaining structure thereof is equal to the structure of the laundry treating apparatus described above. That is, a circulating flow channel of the second heat exchanger 8 in the present embodiment is composed of an intake duct 81, a first heat exchange duct 82, a second heat exchange duct 83, and an exhaust duct 84.

The intake duct 81 is disposed in the device chamber 317, and includes an intake hole 811 into which air of the door chamber is introduced, and a first communication hole 812 and a second communication hole 813 through which air is discharged.

The exhaust duct 84 is disposed in the device chamber 317 and supplies air to the fastening portion flow channel 531 of the clothes hanger. The exhaust duct 84 includes an exhaust duct inlet 841 into which air that has passed through the first heat exchange duct 82 and the second heat exchange duct 83 is introduced, and an exhaust duct outlet (exhaust hole) 842 connected to the exhaust duct connection hole 532 of the fastening portion flow channel. The exhaust duct 84 may be formed in a shape in which a cross-sectional area of a flow channel becomes narrower from the exhaust duct inlet 841 toward the exhaust duct outlet 842.

When the device chamber 317 is composed of the first space 317a and the second space 317b described above, the intake duct 81 may be located in the first space 317a and the exhaust duct 84 may be located in the second space 317b.

The first heat exchange duct 82 may be disposed in the first space 317a of the device chamber to connect the first communication hole 812 with the exhaust duct 84, and the second heat exchange duct 83 may connect the second communication hole 813 with the exhaust duct 84.

The first heat exchange duct 82 provides a space for dehumidifying and heating air supplied from the first communication hole 812, and the second heat exchange duct 83 provides a space for dehumidifying and heating air supplied from the second communication hole 813.

The first heat exchange duct 82 includes a first condensation duct 821 fixed to the first communication hole 812 and extending along the width direction of the door chamber 312, and a first heating duct 823 connecting the first condensation duct 821 with the exhaust duct 84 and disposed in parallel with the first condensation duct 821.

The first condensation duct 821 and the first heating duct 823 may be formed in a stacked structure along the height direction of the device chamber 317. Air in the first condensation duct 821 flows to the first heating duct 823 via a first fan 86.

The first fan 86 may include a first housing 861, a first housing inlet 862 that extends through a top surface of the first housing and is connected to the first condensation duct 821, a first housing outlet 863 that extends through a side surface of the first housing and is connected to the first heating duct 823, and a first impeller 864 disposed inside the first housing.

The first condensation duct 821 may include a first condensation duct inlet 821a connected to the first communication hole 812 and a first condensation duct outlet 821b connected to the first housing inlet 862, and the first heating duct 823 may include a first heating duct inlet 823a connected to the first housing outlet 863 and a first heating duct outlet through which air is discharged.

A first air treater 88 in the present embodiment may be formed as a first thermoelectric module (first heat exchanger) 881 including a first heat absorption fin 882 located inside the first condensation duct 821 and a first heat dissipation fin 883 located inside the first heating duct 823.

A bottom surface of the first condensation duct 821 may have a first heat exchanger first mounting hole 821c into which the first heat absorption fin 882 is inserted, and a top surface of the first heating duct 823 may have a first heat exchanger second mounting hole 823b into which the first heat dissipation fin 883 is inserted.

The second heat exchange duct 83 may include a second condensation duct 831 that is fixed to the second communication hole 813 and extends along the width direction of the door chamber 312, and a second heating duct 833 that connects the second condensation duct 831 with the exhaust duct 84 and is disposed in parallel with the second condensation duct 831.

The second condensation duct 831 is preferably located in an opposite direction to the first condensation duct 821. That is, as shown in FIG. 10, when the first condensation duct 821 is located at the left side of the first door body 311, the second condensation duct 831 may be located at the right side of the first door body 311 based on a vertical line passing through a center of the first door body.

The second condensation duct 831 and the second heating duct 833 may be formed in a stacked structure along the height direction of the device chamber 317. Air in the second condensation duct 831 flows to the second heating duct 833 via a second fan 87.

The second fan 87 may include a second housing 871, a second housing inlet 872 that extends through a top surface of the second housing and is connected to the second condensation duct 831, a second housing outlet 873 that extends through a side surface of the second housing and is connected to the duct 833, and a second impeller 874 disposed inside the second housing.

The second condensation duct 831 may include a second condensation duct inlet 831a connected to the second communication hole 813 and a second condensation duct outlet 831b connected to the second housing inlet 872, and the second heating duct 833 may include a second heating duct inlet 833a connected to the second housing outlet 873 and a second heating duct outlet through which air is discharged.

A second air treater 89 in the present embodiment may be formed as a second thermoelectric module (second heat exchanger) 891 that includes a second heat absorption fin 892 located inside the second condensation duct 831 and a second heat dissipation fin 893 located inside the second heating duct 833.

A bottom surface of the second condensation duct 831 may have a second heat exchanger first mounting hole 831c into which the second heat absorption fin 892 is inserted, and a top surface of the second heating duct 833 may have a second heat exchanger second mounting hole 833b into which the second heat dissipation fin 893 is inserted.

The exhaust duct 84 may be directly connected to the first heating duct 823 and the second heating duct 833 or may be connected to each of the heating ducts 823 and 833 via a connecting duct 85. FIG. 10 shows the latter case as an example.

The connecting duct 85 may be disposed along the depth direction of the door chamber 312 (the X-axis direction) and connect an outlet of the first heating duct 823 and an outlet of the second heating duct 833 to the exhaust duct 84.

The exhaust duct 84 may be coupled to the connecting duct 85 via a connecting duct outlet 851, and a heater 852 that heats air discharged from each of the heating ducts 823 and 833 may be disposed inside the connecting duct 85.

The above-described embodiments are characterized in that air (heated air or unheated air) that has passed through the second heat exchanger 4 and 8 is directly supplied to the laundry (air is supplied into the laundry hung on the clothes hanger). The laundry treating apparatus 100 may further include a flow channel switcher 7 that supplies air that has passed through the second heat exchanger 4 and 8 to the door chamber 312.

In the embodiment of FIG. 7, the flow path switcher 7 may include a switching flow channel 71 connecting the circulating flow channel 41, 42, 44 with the door chamber 312, and a switching valve 72 that controls opening and closing of the switching flow channel 71.

The switching flow channel 71 may be defined as a flow channel extending through the chamber top surface 314 and the heating duct 423. The switching flow channel 71 may discharge air to the clothes hanger 5 or the shelf 32 in the space provided by the chamber top surface 314. FIG. 7 shows a case in which the switching flow channel 71 discharges air to the base 513 of the clothes hanger 5 as an example.

In addition, the switching flow channel 71 may be disposed (an inlet of the switching flow channel is located between the heater 464 and the heat dissipation fin 463) to supply air that has passed through the heat dissipation fin 463 to the door chamber 312, or may be disposed (the inlet of the switching flow channel is located between the heater and the exhaust duct inlet) to supply air that has passed through the heater 464 to the door chamber 312.

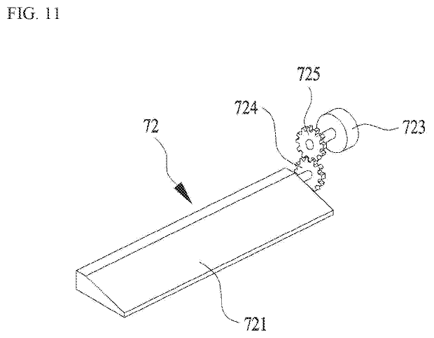

The switching valve 72 may be formed as various devices as long as it may control the opening and closing of the switching flow channel 71. FIG. 11 shows a case in which the switching valve 72 is composed of a switching body 721 that closes the inlet of the switching flow channel 71, a body rotation shaft 722 that rotatably fixes the switching body 721 to the heating duct 423 or the chamber top surface 314, and a body driver that controls rotation of the body rotation shaft as an example.

The switching body 721 may be formed in a shape that may close the inlet of the switching flow channel 71 and an inlet 441 of the exhaust duct. In this case, the switching body 721 may open only the switching flow channel 71, only the exhaust duct 44, or both the switching flow channel and the exhaust duct, depending on a rotation angle.

The body driver may include a motor 723, a first gear 724 fixed to a rotation shaft of the motor, and a second gear 725 fixed to the body rotation shaft 722 and connected to the first gear.

The flow channel switcher 7 may also be in the embodiment of FIG. 10.

The flow channel switcher 7 in the embodiment of FIG. 10 may include a switching flow channel 73 connecting at least one of the first heat exchange duct 82 and the second heat exchange duct 83 to the door chamber 312, and the switching valve 72 that controls the opening and the closing of the switching flow channel 73.

FIG. 10 shows a case in which the switching flow channel 73 connects both the first heat exchange duct 82 and the second heat exchange duct 83 to the door chamber 312 as an example. In this case, the switching flow channel 73 may extend through the chamber top surface 314 and the connecting duct 85 to connect the interior of the connecting duct 85 to the door chamber 312.

An inlet of the switching flow channel 73 may be disposed at a location where air that has passed through the heater 852 may be supplied to the door chamber 312. That is, the heater 852 may be disposed inside the connecting duct 85 so as to be located between a joining point (an entrance of the connecting flow channel) of the first heating duct 823 and the second heating duct 833 and the inlet of the switching flow channel 73.

The laundry treating apparatus 100 equipped with the flow channel switcher 7 described above may perform sensing whether the clothes hanger 5 is mounted in the door chamber 312 via the mounting sensor 6, and controlling the switching valve 72 such that the switching flow channel 71 and 73 is closed when sensing that the clothes hanger is mounted in the door chamber 312.

Unlike as described above, when sensing that the clothes hanger is mounted in the door chamber 312, the laundry treating apparatus 100 may control the switching valve 72 such that both the switching flow channel 71 and 73 and the exhaust duct 44 and 84 are opened. In this case, a rotation angle of the switching body 721 may be set such that an amount of air supplied to the exhaust duct is greater than an amount of air supplied to the switching flow channel.

In one example, when sensing that the clothes hanger is not mounted in the door chamber 312, the laundry treating apparatus 100 may perform the controlling of the switching valve 72 such that the switching flow channel 71 and 73 is opened and the exhaust duct 44 and 84 is closed.

In the embodiment of FIG. 10, the flow channel switcher 7 may be composed of a first switcher that selectively connects the first heating duct 823 with the door chamber 312, and a second switcher that selectively connects the second heating duct 833 with the door chamber 312. In this case, the first switcher may be composed of a first switching flow channel that connects the first heating duct 823 with the door chamber 312 and a first switching valve that controls opening and closing of the first switching flow channel, and the second switcher may be composed of a second switching flow channel that connects the second heating duct 833 with the door chamber 312 and a second switching valve that controls opening and closing of the second switching flow channel.

The laundry treating apparatus 100 equipped with the second heat exchanger 8 in FIG. 10 may operate one of the first air treater 88 and the second air treater 89 or may operate both the air treaters 88 and 89 simultaneously. The first switcher and the second switcher may be controlled to be in association with the operation of the air treaters 88 and 89.

That is, when only the first air treater 88 operates, the flow channel switcher 7 may control the opening and closing of the flow channel only with the first switching valve, and when only the second air treater 89 operates, the flow channel switcher 7 may control the opening and closing of the flow channel with only the second switching valve.

Because the structure, the control method, and the like of the laundry treating apparatus described above relate to the embodiments, the scope of the present application is not limited to the embodiments described above.

1-32. (canceled)

33. A laundry treating apparatus comprising:
a cabinet including a cabinet chamber providing a space for accommodating laundry therein and a first inlet allowing the cabinet chamber to be in communication with an outside of the cabinet chamber;
a first door configured to open or close the first inlet;
a door chamber defined in the first door to provide a laundry accommodation space separated from the cabinet chamber, wherein the door chamber includes a chamber top surface, a chamber bottom surface, a mounting surface connecting the chamber top surface with the chamber bottom surface, and a mounting hole defined through the mounting surface;
a second door disposed at the first door and configured to open and close an second inlet that is provided in the first door and communicating to the door chamber;
a clothes hanger including a support body where the laundry is supported, a fastening portion detachably fixing the support body to the mounting hole, a fastening portion flow channel defined in the fastening portion, and a support body flow channel defined in the support body and configured to supply air supplied from the fastening portion flow channel to the laundry mounted on the support body; and
a heat exchanger including a circulating flow channel configured to discharge air inside the door chamber to an outside of the door chamber and then guide air to the fastening portion flow channel, a fan disposed in the circulating flow channel, and an air treater configured to perform at least one of dehumidification and heating of air introduced into the circulating flow channel.

34. The laundry treating apparatus of claim 33, further comprising a device chamber defined in the first door to define therein a space separated from the door chamber and providing a space where the heat exchanger is mounted.

35. The laundry treating apparatus of claim 34, wherein the circulating flow channel includes an intake duct guiding air in the door chamber into the device chamber, a condensation duct providing a space where air discharged from the intake duct is dehumidified, a heating duct providing a space where air discharged from the condensation duct is heated, and an exhaust duct guiding air discharged from the heating duct to the fastening portion flow channel,
wherein the air treater is formed as a thermoelectric module including a heat absorption fin located inside the condensation duct and a heat dissipation fin located inside the heating duct.

36. The laundry treating apparatus of claim 35, wherein the device chamber includes a first space separated from the door chamber via the chamber top surface and a second space extending from the first space along a height direction of the first door and separated from the door chamber via the mounting surface.

37. The laundry treating apparatus of claim 36, wherein the condensation duct and the heating duct are disposed in the first space and the exhaust duct is disposed in the second space.

38. The laundry treating apparatus of claim 35, wherein the intake duct is located at one of a right side and a left side of the first door,
wherein the condensation duct is located under the intake duct,
wherein the heating duct includes a duct first body extending from the intake duct along a width direction of the first door and a duct second body extending from the duct first body along a depth direction of the first door and connected to the exhaust duct.

39. The laundry treating apparatus of claim 35, wherein the exhaust duct is formed in a shape whose cross-sectional area becomes narrower from the heating duct toward the fastening portion flow channel.

40. The laundry treating apparatus of claim 35, wherein the fan includes a housing connecting the condensation duct with the heating duct, and an impeller disposed inside the housing.

41. The laundry treating apparatus of claim 35, further comprising a heater disposed in one of the heating duct and the exhaust duct to heat air that has passed through the heat dissipation fin.

42. The laundry treating apparatus of claim 35, further comprising:
a mounting body fixed to the device chamber;
a duct mounting portion defined in the mounting body to support the exhaust duct; and
a fastening portion mounting portion defined in the mounting body to support one end of the fastening portion inserted into the mounting hole.

43. The laundry treating apparatus of claim 42, further comprising an exhaust duct connection hole extending through the fastening portion and connected to the fastening portion flow channel, and connected to the exhaust duct when the fastening portion is inserted into the fastening portion mounting portion.

44. The laundry treating apparatus of claim 43, further comprising:
a magnet disposed in the fastening portion; and
a sensor disposed in the mounting body and configured to sense whether the fastening portion is inserted into the fastening portion mounting portion by sensing a magnetic force of the magnet.

45. The laundry treating apparatus of claim 33, wherein the second door includes:
a second door body pivotably coupled to the first door;
a door through-hole extending through the second door body and in communication with the door chamber; and
a transparent body fixed to the second door body to close the door through-hole and made of a transparent material.

46. The laundry treating apparatus of claim 33, wherein the support body includes a base where the fastening portion is fixed, and a first support and a second support fixed to the base to provide spaces for supporting the laundry and located at symmetrical points around the base,
wherein the support body flow channel guides air to an exhaust hole defined in at least one of the base, the first support, and the second support.

47. The laundry treating apparatus of claim 33, wherein the circulating flow channel has an intake hole through which air inside the door chamber is introduced into the circulating flow channel, and the intake hole is located above the second inlet.
